(19) United States
(12) Patent Application Publication
(10) Pub. No.: US 2010/0083331 A1
(43) Pub. Date: Apr. 1, 2010

(54) MOBILE TERMINAL DEVICE, BACKUP VIEWING SERVICE SYSTEM, AND BACKUP VIEWING SERVICE METHOD

(75) Inventor: Shin-ya Kashiwada, Sendai-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi (JP)

(21) Appl. No.: 12/516,334

(22) PCT Filed: Nov. 27, 2006
(86) PCT No.: PCT/JP2006/323616

§ 371 Date: May 26, 2009

(51) Int. Cl. H04N 7/173

(52) U.S. Cl. 725/115

(57) ABSTRACT

A mobile terminal device and a backup viewing service system, capable of reflecting user's interest and wishes in utilizing a backup viewing service are provided. A mobile terminal device 50 for receiving a digital terrestrial broadcasting oriented to the mobile terminal from a broadcasting station 10 is equipped with a controlling portion 61, a setting saving portion 56 for saving information being set by a user, and a genre saving portion 57 for counting a number of times of the digital broadcasting program that the user watches every genre and saving the count. When the “genre viewed X times in the past” is selected from a genre selection menu, the controlling portion 61 refers to the set number of viewing times save in the setting saving portion 56 and the number of viewing times saved in the genre saving portion 57, and then compares them with each other. When the number of viewing times exceeds the set number of viewing times, such a situation is set automatically that the backup viewing service is set into available in that genre.

### TECHNICAL FIELD

The present invention relates to a mobile terminal device, a backup viewing service system, and a backup viewing service method, which utilize a backup viewing service when a broadcast program that is being received falls into a viewing impossible state in a digital terrestrial broadcasting, or the like.

### BACKGROUND ART

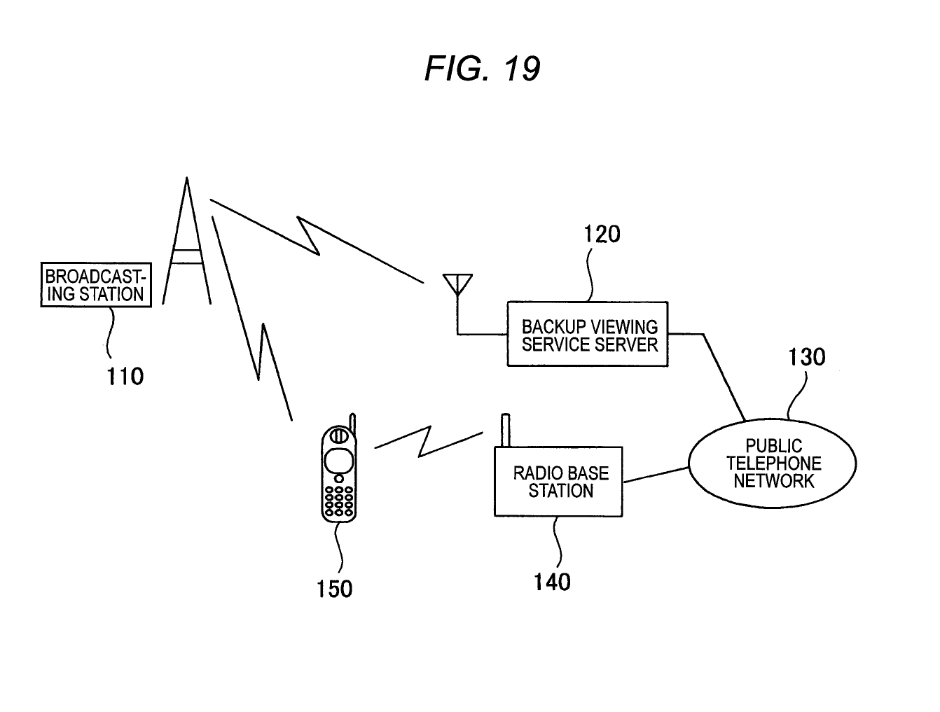

FIG. 19 is a view showing a configurative example of a digital broadcasting system oriented to a mobile terminal in the prior art. This digital broadcasting system oriented to the mobile terminal is constructed to include a broadcasting station 110, a backup viewing service server 120, a public telephone network 130, a radio base station 140, and a mobile terminal device 150.

The broadcasting station 110 delivers the digital terrestrial broadcasting oriented to the mobile terminal. The backup viewing service server 120 receives the digital broadcasting from the broadcasting station 110, and converts program contents of the digital broadcasting into contents data for the backup viewing service such as fast playback file, digest contents, and the like and accumulates the contents data therein. The public telephone network 130 and the radio base station 140 distribute the contents data for the backup viewing service in the backup viewing service server 120 to the mobile terminal device 150.

The mobile terminal device 150 has a function of receiving directly the digital broadcasting from the broadcasting station 110, and a function of supplementing the portions that a user fails to view from the backup viewing service server 120 to allow their viewing when the user could not view the digital broadcasting program from the broadcasting station 110 on account of receiving error, etc.

Concretely, when the user could not watch the digital terrestrial broadcasting oriented to the mobile terminal due to a BER (Bit Error Rate), or the like while such user is receiving the program on the mobile terminal device 150 to view it, a time at which the viewing becomes impossible is sent out from the mobile terminal device 150 to the radio base station 140 via packet communication. Then, a time at which the viewing becomes possible is sent out again to the radio base station 140 after the user can view the digital terrestrial broadcasting.

The backup viewing service server 120 receives a time at which the viewing becomes impossible and a time at which the viewing becomes possible from the radio base station 140 via the public telephone network 130. Then, the backup viewing service server 120 creates digest contents of the program contents between both times or a fast playback file, and distributes the contents or the file from the radio base station 140 to the mobile terminal device 150. The mobile terminal device 150 plays the distributed digest contents or fast playback file.

Broadcasting time information is multiplexed in the distributed digest contents or fast playback file. The mobile terminal device 150 monitors the broadcasting time information, and switches automatically the station to receive the digital broadcasting at a time the broadcasting time information catches up with a present time. As a result, the user can enjoy the digital broadcasting without interruption of the program contents.

In this manner, in the digital broadcasting system oriented to the mobile terminal in the prior art, when the user could not watch the program due to a degradation in BER (Bit Error Rate), or the like in course of reception of the digital broadcasting on the mobile terminal device, the contents data for the backup viewing service can be distributed to the mobile terminal device from the backup viewing service server. As a result, the user can watch the program portion that the user failed to view, as the backup program.

Patent Literature 1: JP-A-2004-349932

### DISCLOSURE OF THE INVENTION

### Problems that the Invention is to Solve

However, in the backup viewing service system in the prior art, there are problems enumerated below, and improvements are demanded. That is, user's interest in genre was not reflected in the program that the user is viewing now. So the backup viewing service is applied to the program contents in which the user does not get an interest at all and for which such service is not needed.

Also, in such a situation that the user watches the program in a particular genre with great frequency out of the digital broadcasting that the user is watching, the problem mentioned below existed. Here, assume that the user possess a keen interest in the genre. When the program in the genre in which the user possess an interest falls into the viewing impossible state while the user is watching such program, the user had to make the setting to utilize the backup viewing service every program that such user is viewing.

Also, it was not clear which one of the digest contents and the fast playback file can be selected as the contents data for the backup viewing service, which are distributed via the backup viewing service.

Also, when the program in the genre in which the user possess an interest falls into the viewing impossible state in course of watching this program and then such program is recorded by the backup viewing service server, a following problem arose. That is, when the distribution of the digest contents or the fast playback file is not needed even if the program belongs to the genre in which the user possess an interest, the digest contents or the fast playback file is distributed automatically against user's will.

Also, because a threshold value of the picture quality in which the backup viewing service is needed, i.e., the bit error rate (BER), is not set by the user, the backup viewing service is utilized even in the case of “the backup viewing service is not needed if a deterioration in picture quality is slight”, for example. Since repetition of such situation brings about a lack of the resources in the backup viewing service server, there was such a possibility that the drawbacks such that the user cannot utilize the backup viewing service about critical portions, and the like are caused.

The present invention has been made in view of the above circumstances, and it is an object of the present invention to provide a mobile terminal device, a backup viewing service system, and a backup viewing service method, capable of reflecting user's interest and wishes in utilizing a backup viewing service.

### Means for Solving the Problems

A mobile terminal device of the present invention that utilizes a backup viewing service when a broadcast program that is being received falls into a viewing impossible state, includes an inputting portion for inputting utilization condition for the backup viewing service; a utilization condition setting portion for setting the input utilization condition for the backup viewing service; a utilization condition discriminating portion for discriminating whether or not the set utilization condition is satisfied, when the broadcast program that is being received falls into the viewing impossible state; and a service availability setting portion for setting the backup viewing service into available when the utilization condition is satisfied.

Accordingly, the user's interest and wishes can be reflected in utilizing a backup viewing service

Also, in the mobile terminal device of the present invention, the utilization condition setting portion sets a number of set times being input by the inputting portion every genre as the utilization condition of the backup viewing service, and the utilization condition discriminating portion discriminates that the utilization condition is satisfied, when a number of viewing times of the genre corresponding to the broadcast program that is being received exceeds the number of set times.

Accordingly, the setting indicating whether or not the backup viewing service should be utilized every broadcasting program can be omitted.

Also, in the mobile terminal device of the present invention, the utilization condition setting portion sets a number of set times of the backup viewing service being input by the inputting portion every genre as the utilization condition of the backup viewing service, and the utilization condition discriminating portion discriminates that the utilization condition is satisfied, when a number of utilizing times of the backup viewing service in the genre corresponding to the broadcast program that is being received exceeds the number of set times.

Accordingly, the setting indicating whether or not the backup viewing service should be utilized every broadcasting program can be omitted.

Also, in the mobile terminal device of the present invention, the utilization condition setting portion sets a degree of degradation in picture quality as the utilization condition of the backup viewing service, and the utilization condition discriminating portion discriminates that the utilization condition is satisfied, when picture quality of the broadcast program that is being received is inferior to the set degree of degradation in the picture quality.

Accordingly, the user can set freely a degree of degradation in picture quality in utilizing the backup viewing service. Since the backup viewing service is rendered unavailable when the degradation in picture quality is slight, the lack of the resources in the backup viewing service server caused when the backup viewing service is provided repeatedly can be solved.

Also, in the mobile terminal device of the present invention, the utilization condition setting portion selects the degree of degradation in the picture quality from a plurality of levels and sets the degree of degradation in the picture quality.

Accordingly, the user can set simply a degree of degradation in picture quality in utilizing the backup viewing service.

Also, the mobile terminal device of the present invention further includes a suspend request accepting portion for accepting a suspend request for the utilization of the backup viewing service; wherein the service availability setting portion suspends the utilization of the backup viewing service when the suspended request accepting portion accepts the suspend request.

Accordingly, when the backup viewing service is not needed even though the programs belongs to the genre in which the user possesses an interest, the user can suspend the backup viewing service at will.

Also, the mobile terminal device of the present invention further includes a displaying portion for displaying a list of utilization conditions of the backup viewing service; wherein the inputting portion inputs the utilization condition of the backup viewing service selected by the user from the list being displayed.

Accordingly, the operability in setting the utilization conditions can be improved.

Also, the mobile terminal device of the present invention further includes a displaying portion for displaying types of the contents data for the backup viewing service provided in the backup viewing service; wherein the inputting portion inputs a type of the contents data for the backup viewing service selected by the user from the data being displayed.

Accordingly, the type of the contents data for the backup viewing service distributed by the backup viewing service can be made clear. For example, the digest contents or the fast playback file can be selected.

Also, the mobile terminal device of the present invention further includes a communicating portion for transmitting utilization setting information concerning an availability of the backup viewing service and viewing impossibility information concerning a viewing disabled state of the broadcasting program to a backup viewing service equipment that serves the backup viewing service; wherein the contents data for the backup viewing service distributed from the backup viewing service equipment is received through the communicating portion.

Accordingly, the backup viewing service equipment can edit the provided contents data for the backup viewing service in response to the user's set contents.

Also, in the mobile terminal device of the present invention, the utilization condition setting portion is able to set the utilization condition of the backup viewing service being input by the inputting portion, in course of reception of the broadcasting program or prior to a start of the reception of the broadcasting program.

Accordingly, the user's convenience in utilizing the backup viewing service can be improved.

A backup viewing service system of the present invention in which a backup viewing service equipment provides a backup viewing service to a mobile terminal device when a broadcast program that is being received on the mobile terminal device falls into a viewing impossible state, wherein the mobile terminal device includes an inputting portion for inputting a utilization condition for the backup viewing service, a utilization condition setting portion for setting the input utilization conditions for the backup viewing service, a utilization condition discriminating portion for discriminating whether or not the set utilization condition is satisfied, when the broadcast program that is being received falls into the viewing impossible state, a service availability setting portion for setting the backup viewing service into available when the utilization condition is satisfied, and a communicating portion for transmitting utilization setting information concerning an availability of the backup viewing service and viewing impossibility information concerning a viewing impossible state of the broadcasting program to a backup viewing service equipment, and the backup viewing service equipment includes a communicating portion for receiving the utilization setting information and the viewing impossibility information from the mobile terminal device, an editing portion for editing contents data for the backup viewing service by recording the broadcasting program that falls into the viewing impossible state, based on the utilization setting information and the viewing impossibility information, and a distributing portion for distributing the edited contents data for the backup viewing service to the mobile terminal device.

A backup viewing service method of the present invention by which a backup viewing service equipment provides a backup viewing service to a mobile terminal device when a broadcast program that is being received on the mobile terminal device falls into a viewing impossible state, wherein, in the mobile terminal device, there are provided an inputting step of inputting a utilization condition for the backup viewing service, a utilization condition setting step of setting the input utilization condition for the backup viewing service, a utilization condition discriminating step of discriminating whether or not the set utilization condition is satisfied, when the broadcast program that is being received falls into the viewing impossible state, a service availability setting step of setting the backup viewing service into available when the utilization condition is satisfied, and a communicating step of transmitting utilization setting information concerning an availability of the backup viewing service and viewing impossibility information concerning a viewing impossible state of the broadcasting program to a backup viewing service equipment, and, in the backup viewing service equipment, there are provided a receiving step of receiving the utilization setting information and the viewing impossibility information from the mobile terminal device, an editing step of editing contents data for the backup viewing service by recording the broadcasting program that falls into the viewing impossible state, based on the utilization setting information and the viewing impossibility information, and a distributing step of distributing the edited contents data for the backup viewing service to the mobile terminal device.

Also, the present invention provides a program for causing a computer to function as respective portions of the mobile terminal device set forth in any one of above.

### ADVANTAGES OF THE INVENTION

According to the present invention, the mobile terminal device, the backup viewing service system, and the backup viewing service method, which are capable of reflecting user's interest and wishes in utilizing the backup viewing service can be provided.

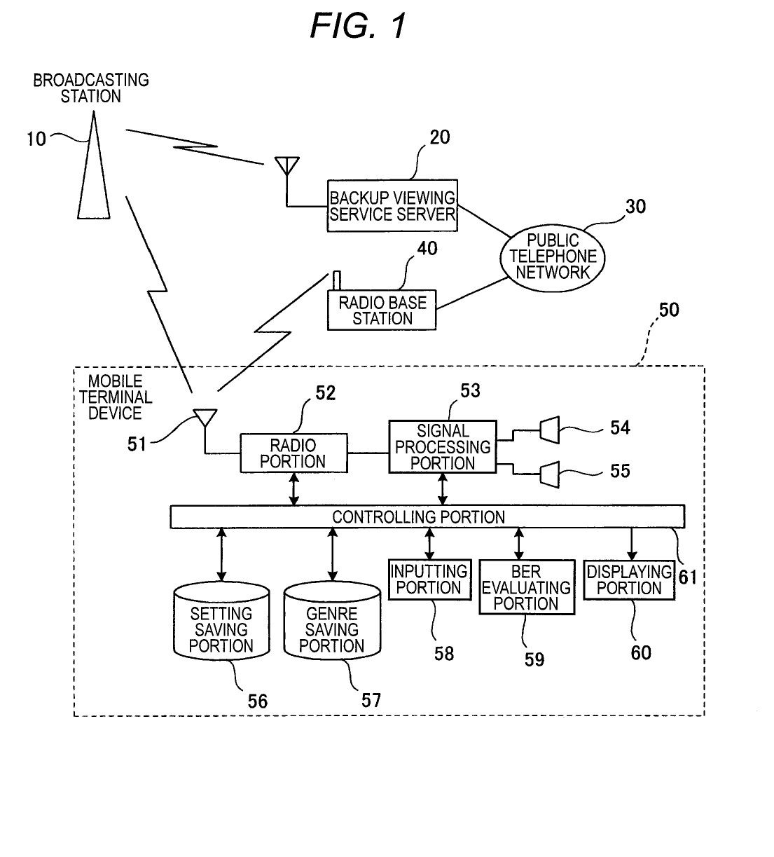

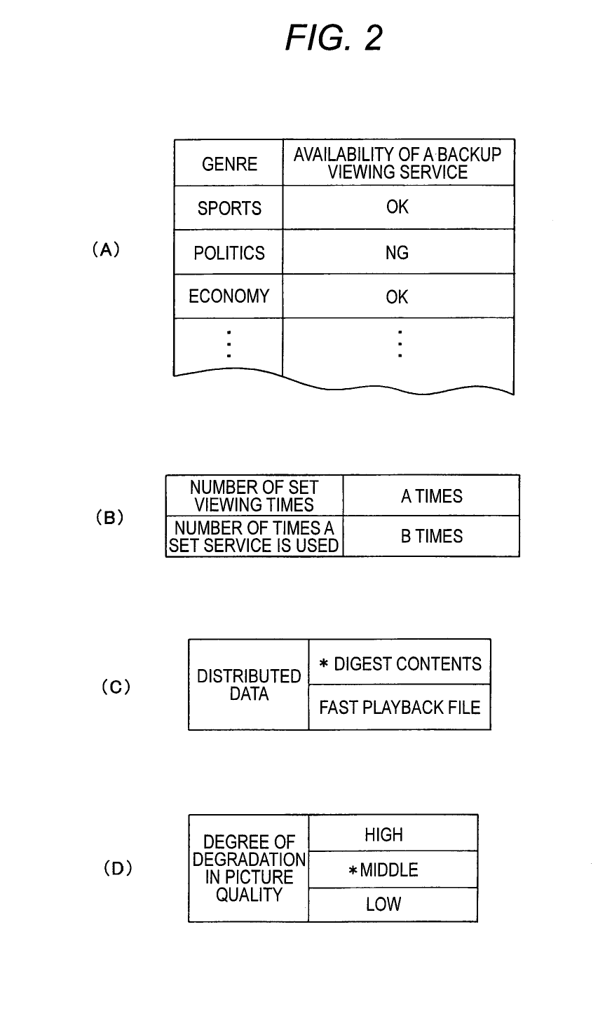

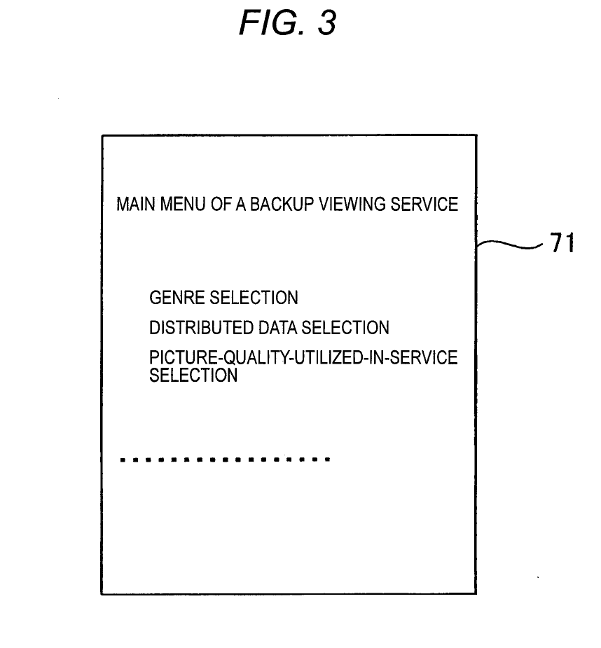

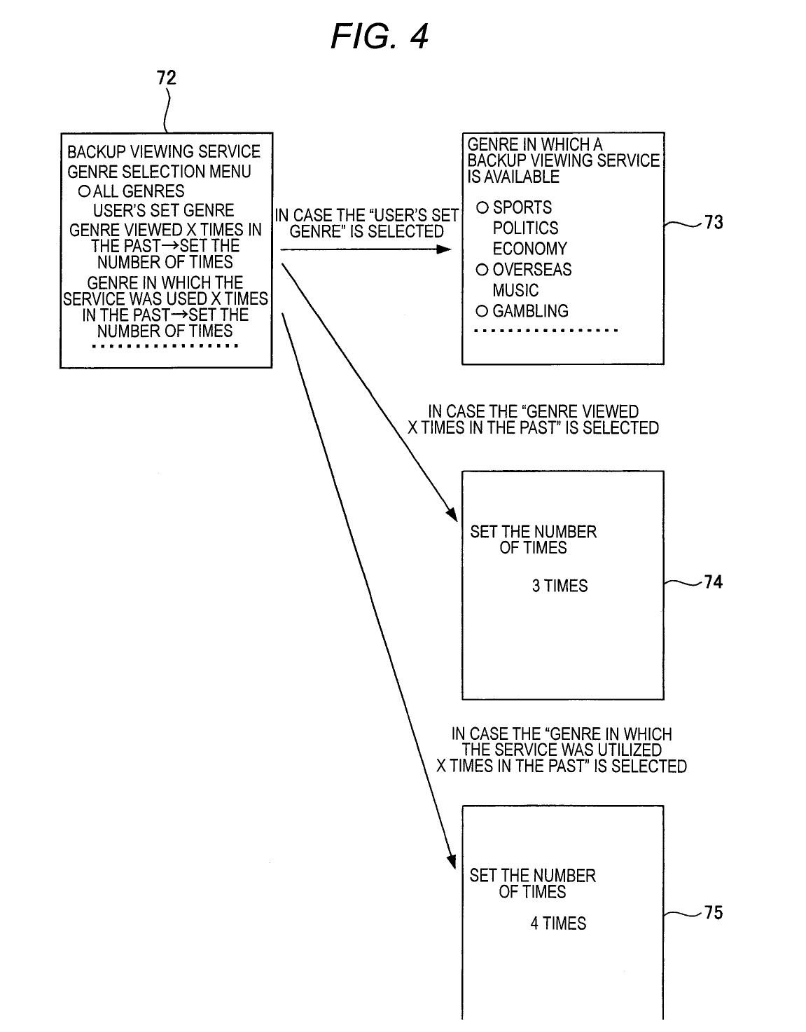

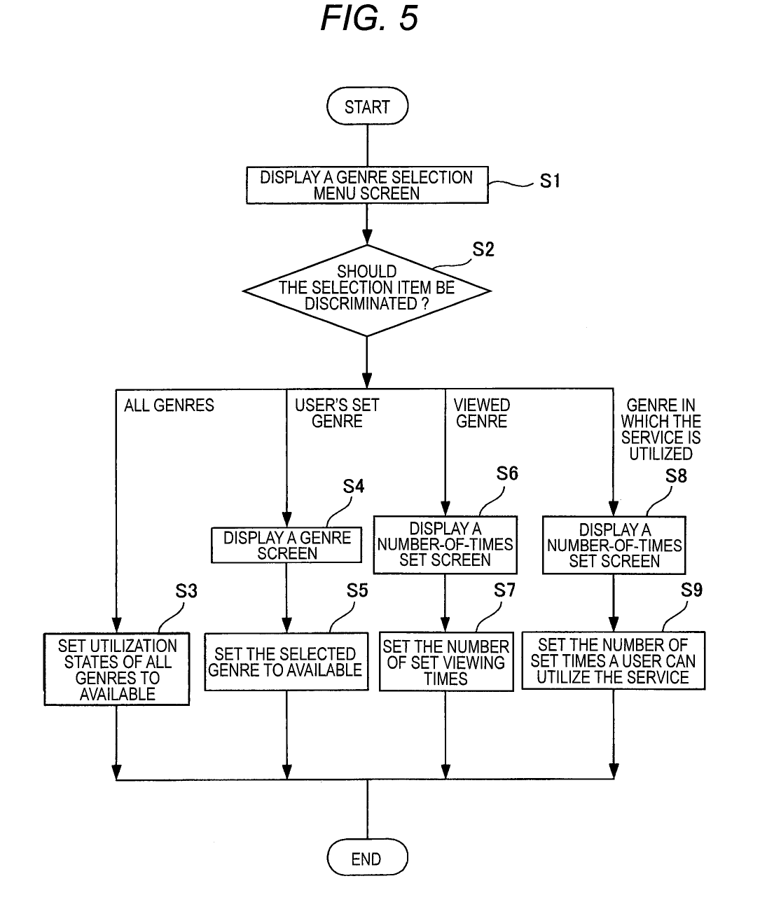

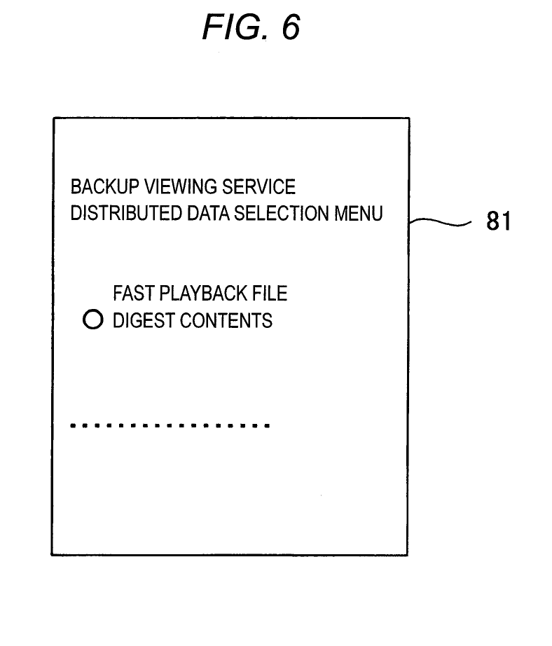

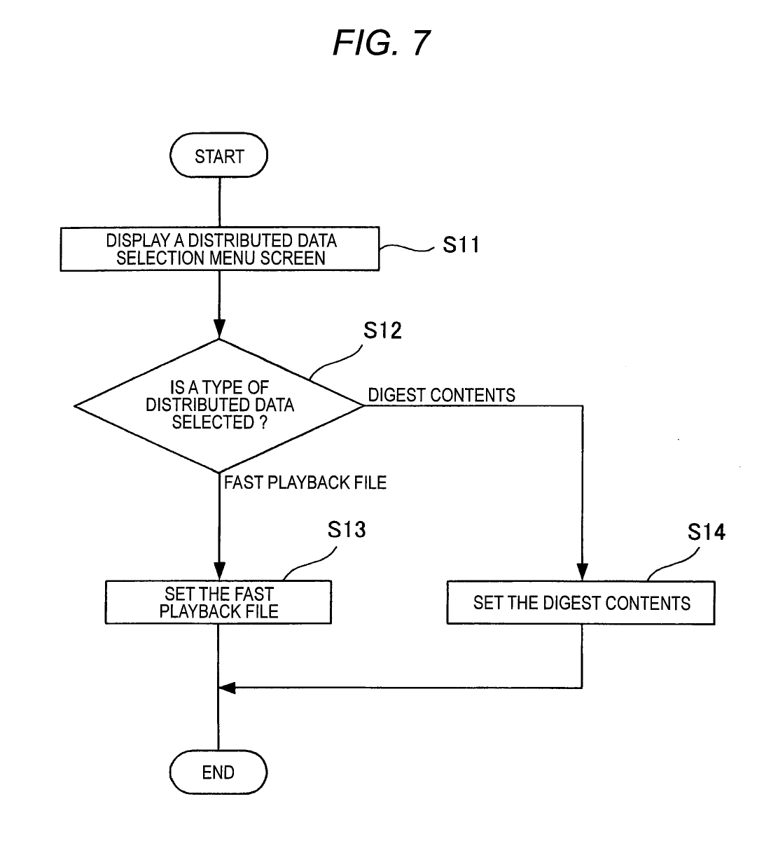

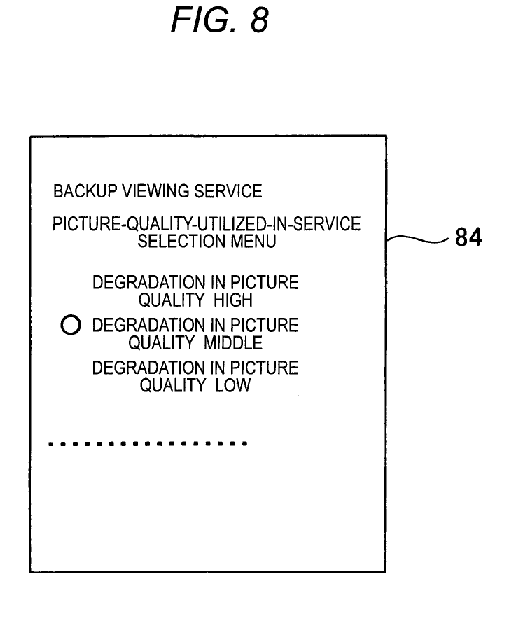

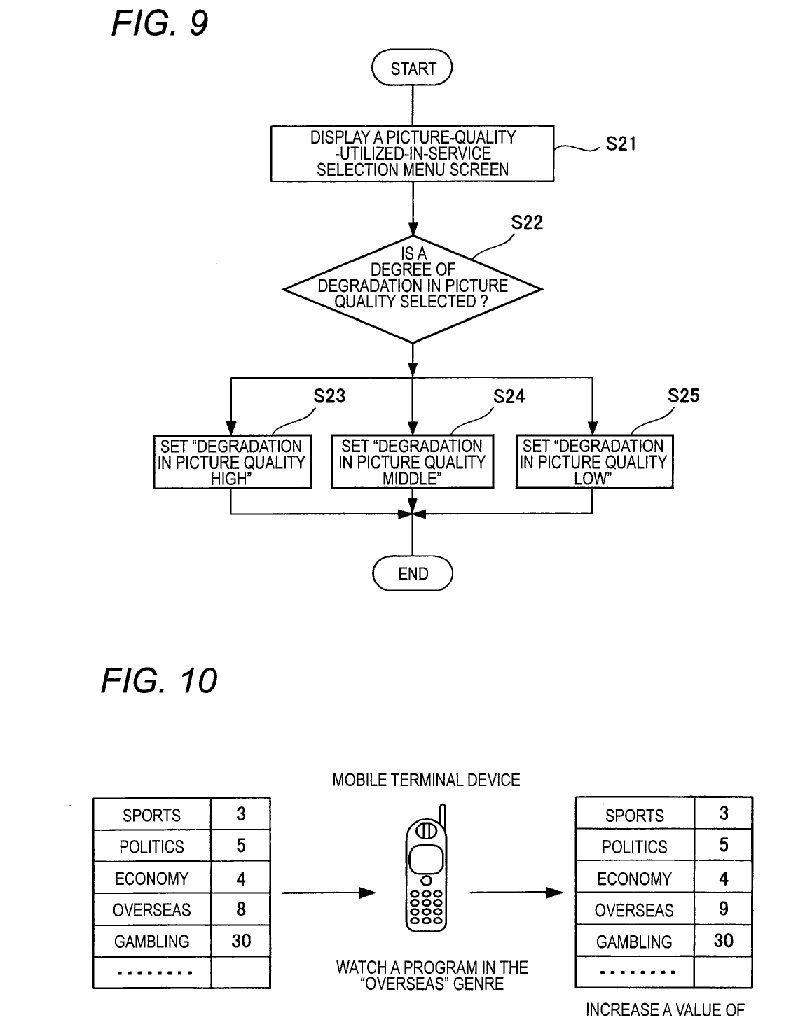

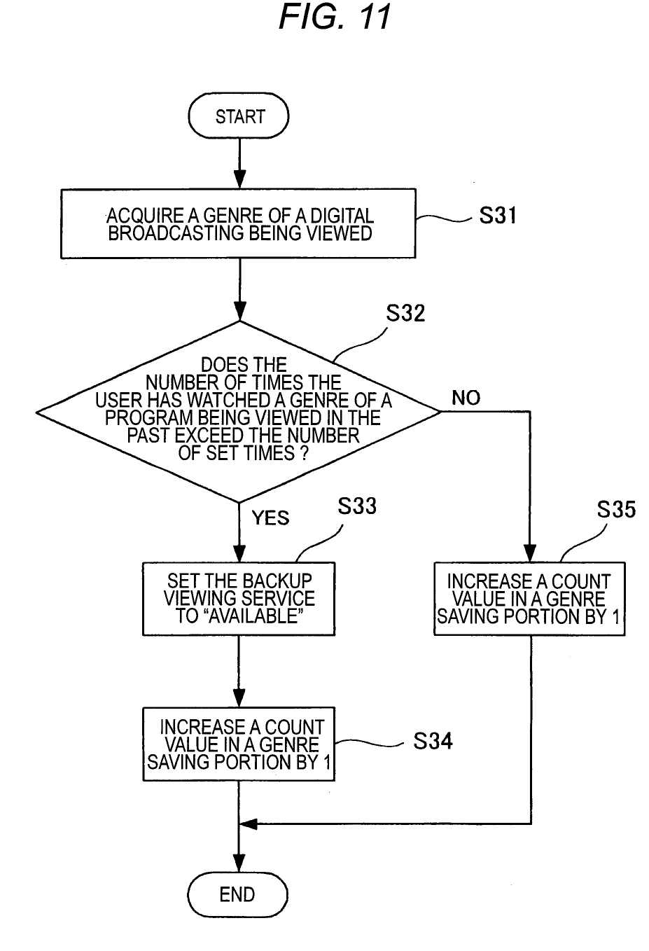

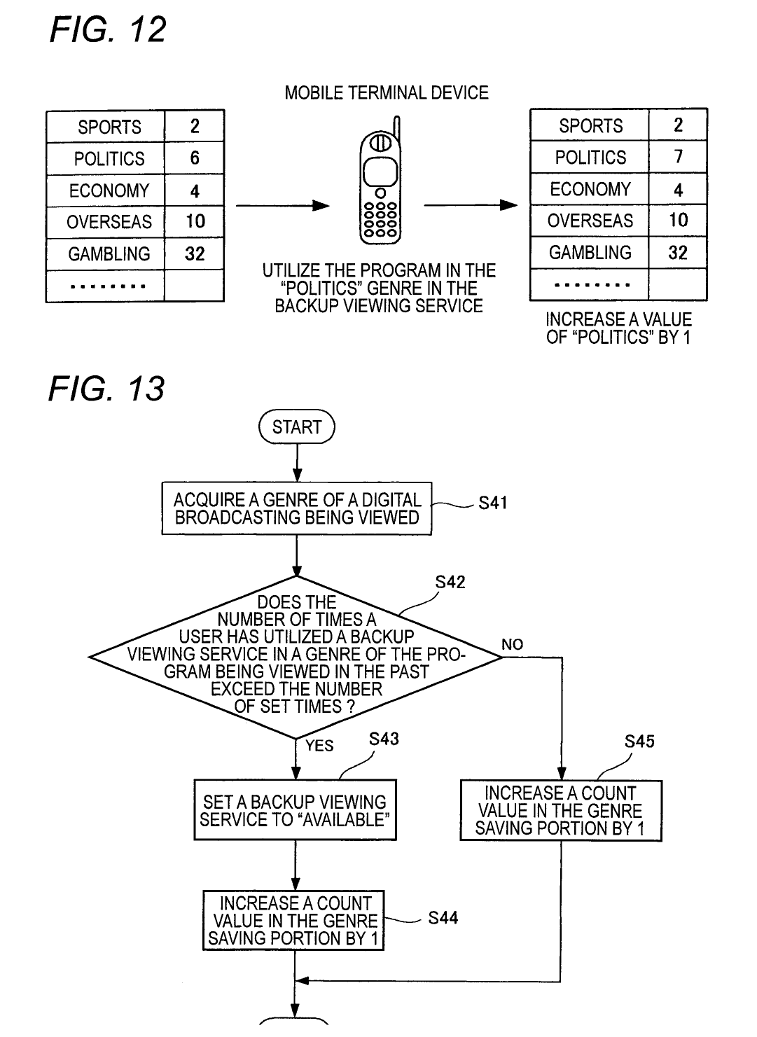

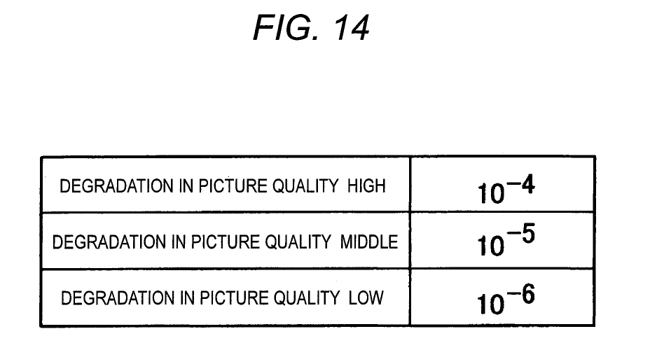

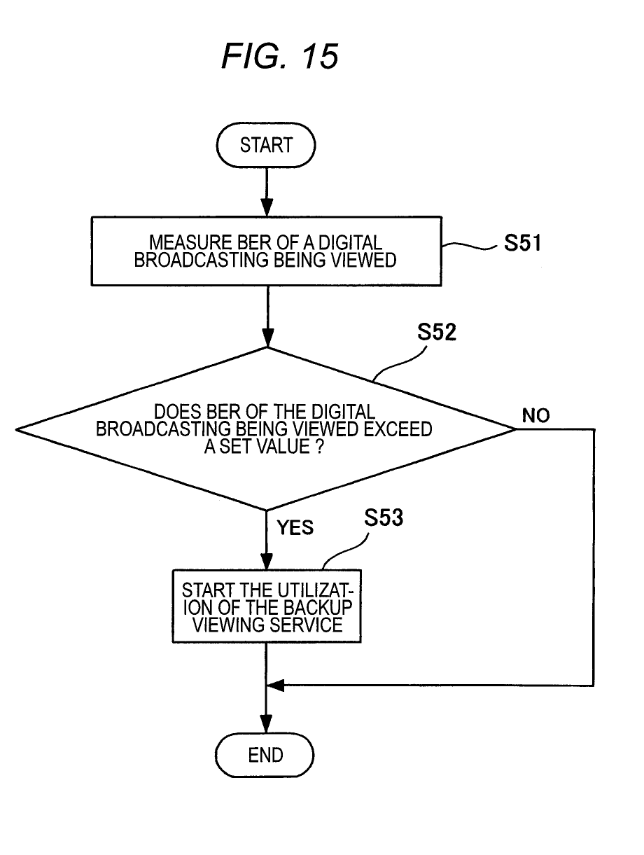

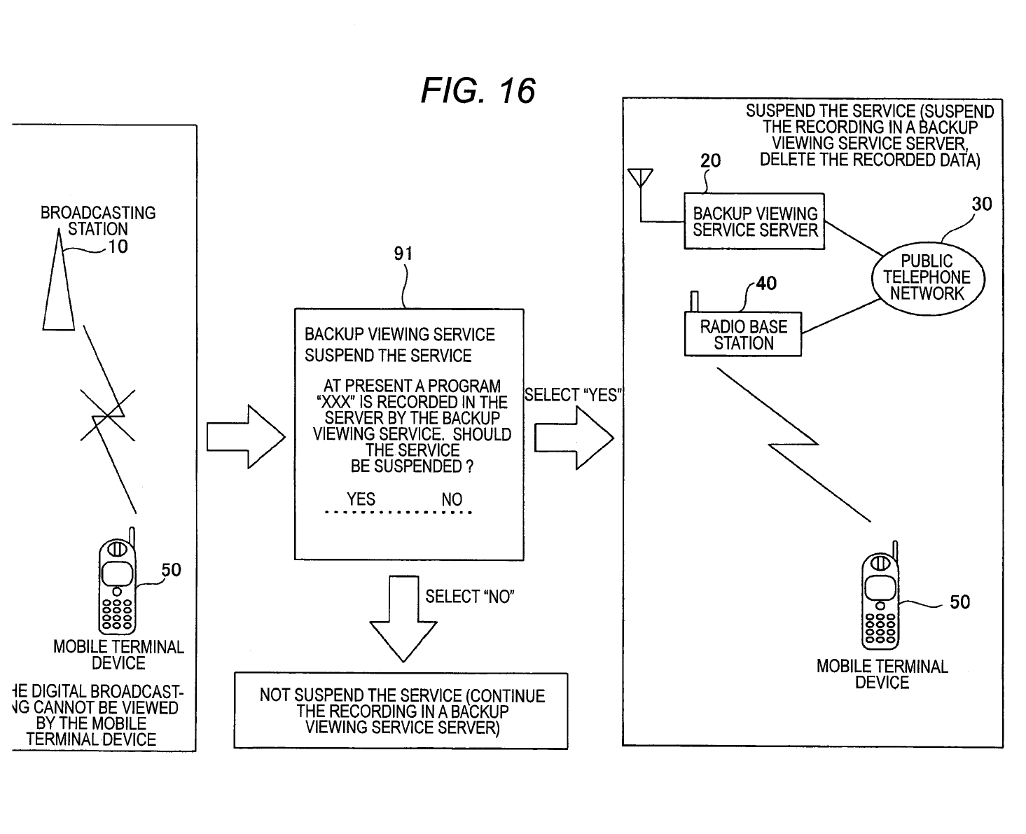

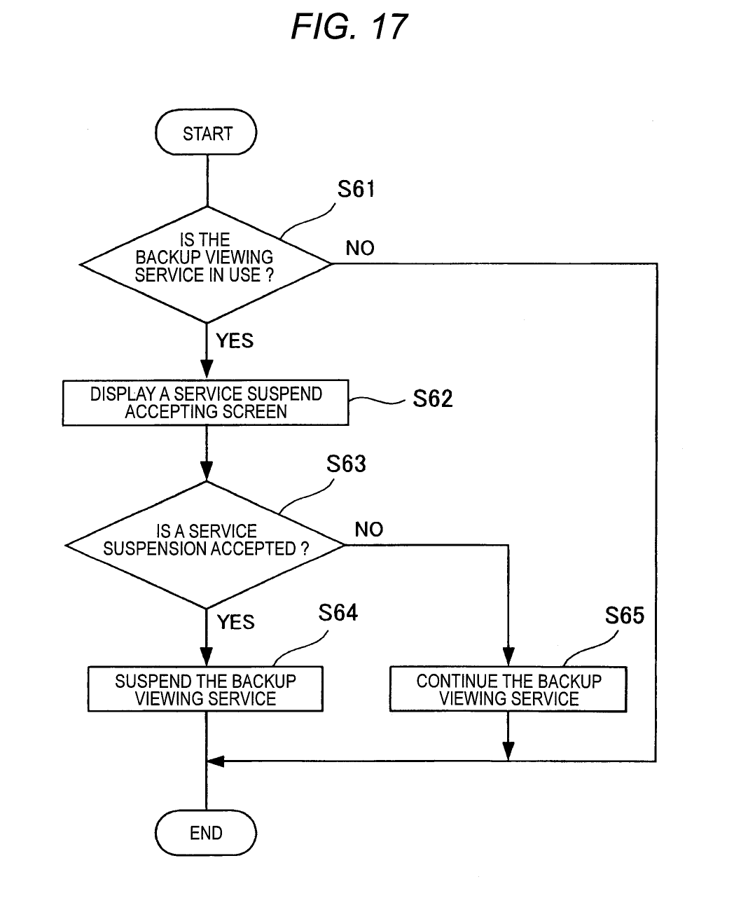

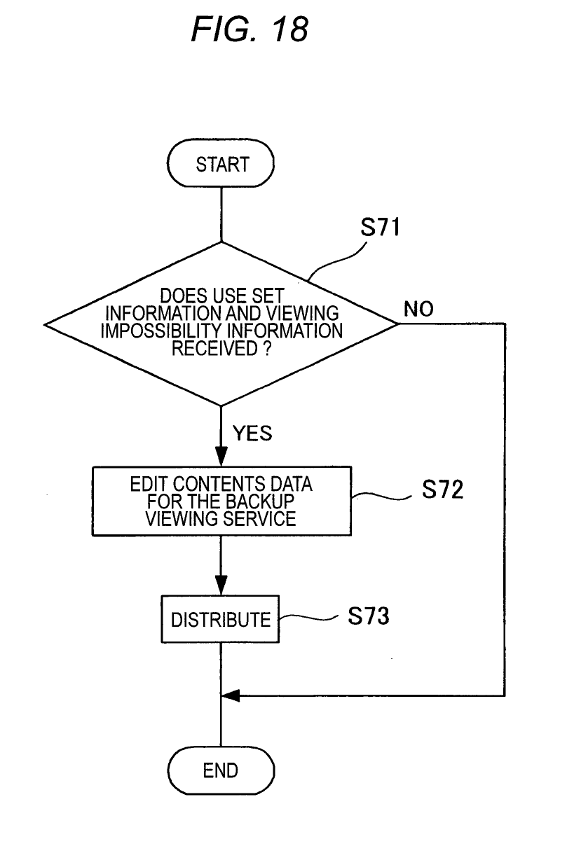

### BRIEF DESCRIPTION OF THE DRAWINGS

[FIG. 1] A view showing a configuration of a digital broadcasting system according to an embodiment of the present invention.

[FIG. 2] Tables showing an utilization OK/NG situation of a backup viewing service every genre, the number of set times, a type of distributed data, and a degree of degradation in picture quality according to the present embodiment.

[FIG. 3] A view showing a main menu screen of the backup viewing service in the present embodiment.

[FIG. 4] A view showing a screen transition when a “genre selection” is selected on the main menu screen in the present embodiment.

[FIG. 5] A flowchart showing setting process procedures done when the “genre selection” is selected on the main menu screen in the present embodiment.

[FIG. 6] A view showing a distributed data selection menu screen when a “distributed data selection” is selected on the main menu screen in the present embodiment.

[FIG. 7] A flowchart showing setting process procedures done when the “distributed data selection” is selected on the main menu screen in the present embodiment.

[FIG. 8] A view showing a “picture-quality-utilized-in-service choosing” menu screen shifted when a “picture-quality-utilized-in-service selection” is selected on the main menu screen in the present embodiment.

[FIG. 9] A flowchart showing setting process procedures done when the “picture-quality-utilized-in-service selection” is selected on the main menu screen in the present embodiment.

[FIG. 10] A view showing a number-of-viewing-times database in a genre saving portion in the present embodiment.

[FIG. 11] A flowchart showing process procedures in utilizing the backup viewing service by using the number of viewing times in the present embodiment.

[FIG. 12] A view showing a number-of-used-times-of-backup-service database in the genre saving portion in the present embodiment.

[FIG. 13] A flowchart showing process procedures in utilizing the backup viewing service by using the number of used times in the present embodiment.

[FIG. 14] A table showing a bit error rate (BER) corresponding to a degree of degradation in picture quality according to the present embodiment.

[FIG. 15] A flowchart showing starting process procedures of the backup viewing service due to a degradation in picture quality in the present embodiment.

[FIG. 16] A view showing a suspending operation of the backup viewing service by a manual operation in the present embodiment.

[FIG. 17] A flowchart showing suspending operation process procedures of the backup viewing service in the present embodiment.

[FIG. 18] A flowchart showing distributing process procedures of contents data for the backup viewing service in a backup viewing service server in the present embodiment.

[FIG. 19] A view showing a configurative example of a digital broadcasting system oriented to a mobile terminal in the prior art.

### DESCRIPTION OF REFERENCE NUMERALS

10 broadcasting station
20 backup viewing service server
30 public telephone network
40 radio base station
50 mobile terminal device
51 antenna
52 radio portion
53 signal processing portion
56 setting saving portion
57 genre saving portion
58 inputting portion
59 BER evaluating portion
60 displaying portion
61 controlling portion

### BEST MODE FOR CARRYING OUT THE INVENTION

In a following embodiment, respective configurative examples of a backup viewing service system applied to a digital terrestrial broadcasting system oriented to a cellular phone and a mobile terminal device are illustrated.

FIG. 1 is a view showing a configuration of a digital broadcasting system according to an embodiment of the present invention. The digital broadcasting system is constructed to include a broadcasting station 10, a backup viewing service server 20, a public telephone network 30, a radio base station 40, and a mobile terminal device 50.

The broadcasting station 10 delivers the digital terrestrial broadcasting oriented to the mobile terminal, and distributes broadcasting contents to respective mobile terminals. The backup viewing service server 20 receives the digital broadcasting from the broadcasting station 10, and converts (edits) contents of the broadcasting program into contents for the backup viewing service such as fast playback file, digest contents, and the like and accumulates the contents therein. Also, the backup viewing service server 20 is constructed by an information processing equipment, and is equipped with a function of a communicating portion that receives information (utilization setting information and viewing NG information) transmitted from the mobile terminal device 50, described later, via the public telephone network 30. Also, the backup viewing service server 20 is equipped with a function of an editing portion that edits the contents data for the backup viewing service by using the recorded program contents based on the received utilization setting information and viewing NG information, and a function of a distributing portion that distributes the contents data for the backup viewing service to the mobile terminal device 50.

The public telephone network 30 and the radio base station 40 relays the contents for the backup viewing service distributed from the backup viewing service server 20 to the mobile terminal device 50. The radio base station 40 holds a sound communication, a packet communication, etc. with the mobile terminal device 50.

The mobile terminal device 50 receives the digital broadcasting for the mobile terminal transmitted from the broadcasting station 10, and enables the user to view the broadcasting program. Also, when the user could not watch the broadcasting program transmitted from the broadcasting station 10, the mobile terminal device 50 supplements the portions that the user failed to view, by the contents for the backup viewing service distributed from the backup viewing service server 20 to enables the user to view such portions.

The mobile terminal device 50 has a controlling portion 61 as a major constituent element. The controlling portion 61 has a processor such as CPU, or the like and a memory such as ROM, RAM, or the like, and performs various controlling process operations based on a predetermined program. Accordingly, respective functions of a utilization condition setting portion, a utilization condition discriminating portion, a service availability setting portion, and a suspend request accepting portion in the controlling portion 61. A radio portion 52, a signal processing portion 53, a setting saving portion 56, a genre saving portion 57, an inputting portion 58, a BER evaluating portion 59, and a displaying portion 60 are connected to the controlling portion 61. Also, a speaker 54 and a microphone 55 are connected to the signal processing portion 53. An antenna 51 is connected to the radio portion 52.

The antenna 51 receives a radio wave from the broadcasting station 10, and transmits/receives the sound and the packet data to/from the radio base station 40. The radio portion 52 has a function of the communicating portion, and performs a down conversion and a demodulating process for converting a radio wave received from the broadcasting station 10 into a signal in a low frequency band. Also, the radio portion 52 performs a modulating process and an up conversion of the sound and the packet data. The signal processing portion 53 converts the signal demodulated by the radio portion 52 into the sound signal by processing the signal, and outputs the sound from the speaker 54. Also, the signal processing portion 53 converts the sound received by the microphone 55 into the electric signal, and converts into the signal suitable for the process in the radio portion 52.

The setting saving portion 56 saves the information being set by the user. Concretely, the set information such as “whether or not the backup viewing service should be done”, “the backup viewing service should be utilized when a picture quality is degraded seriously”, “the backup viewing service should be utilized when a picture quality is degraded slightly”, etc., described later, are saved. Also, as the set information, the number of set viewing times in viewing the digital broadcasting program and the number of set times the user can use the service in utilizing the backup viewing service are saved. Also, these information are saved in a table shown in FIG. 2.

FIG. 2 is tables showing a utilization OK/NG situation of the backup viewing service every genre, the number of set times, a type of distributed data, and a degree of degradation in picture quality. FIG. 2(A) is a table indicating an utilization OK/NG situation of the backup viewing service every genre (utilization OK/NG situation table). Here, “sports”, “politics”, and “economy” are set to “OK”, “NG”, and “OK” in use of the backup viewing service respectively. FIG. 2(B) is a table indicating values of “the number of set viewing times” and “the number of times the set service is used”, described later. FIG. 2(C) is a table indicating types of the contents for the backup viewing service selected as distributed data. Here, as the contents for the backup viewing service, “digest contents” out of “digest contents” and “fast playback file” is selected. In FIG. 2(C), “*” indicates that this item is selected. FIG. 2(D) is a table indicating the setting of a degree of degradation in picture quality. Here, as a degree of degradation in picture quality, a “middle” out of “high”, “middle”, and “low” is set.

The genre saving portion 57 counts the number of times of the digital broadcasting program the user watches every genre, and saves the number of times in a number-of-viewing-times database (see FIG. 10). This number-of-viewing-times database is provided in the genre saving portion 57. Also, the genre saving portion 57 counts the number of times the backup viewing service is utilized every genre, and saves the number of times in a number-of-used-times-of-backup-service database (see FIG. 12). Also, this number-of-used-times-of-backup-service database is provided in the genre saving portion 57.

The inputting portion 58 is an interface through which the user makes the setting in utilizing the backup viewing service. The BER evaluating portion 59 measures a bit error rate (BER) from the signal that is demodulated by the radio portion 52. Also, a table indicating a degree of degradation in picture quality showing the BER value corresponding to a degree of degradation in picture quality (see FIG. 14) is stored in the BER evaluating portion 59.

The displaying portion 60 displays videos of the digital broadcasting program and videos of the digest contents or the fast playback file distributed from the backup viewing service server 20. Also, the displaying portion 60 displays various information and screens in utilizing the backup viewing service described later.

Next, an operation of the backup viewing service system having the above configuration will be explained hereunder. At first, the case where utilization conditions of the backup viewing service are set in view of user's interest and intention is explained. FIG. 3 is a view showing a main menu screen 71 of the backup viewing service. The main menu screen 71 is displayed on the displaying portion 60 of the mobile terminal device 50. Items of “genre selection”, “distributed data selection”, and “picture-quality-utilized-in-service selection” are displayed on the main menu screen 71. The user can set the selected item by moving a cursor key to any one item via the inputting portion 58 and then pressing an OK key in this state.

In FIG. 3, the “genre selection” is the item used to select a genre in which the backup viewing service is provided. The “distributed data selection” is the item used to select the type of data that is distributed when the backup viewing service is utilized. That is, either of the digest contents and the fast playback file is selected as the distributed data. The “picture-quality-utilized-in-service selection” is the item used to a degree of degradation in the received image in utilizing the backup viewing service. That is, the selection and the evaluation the bit error rate (BER) are executed.

FIG. 4 is a view showing a screen transition when the “genre selection” is selected on the main menu screen 71. When the “genre selection” is selected on the main menu screen 71, a genre selection menu screen 72 is displayed on the displaying portion 60. Any one item out of “all genres”, “user's set genre”, “genre viewed X times in the past”, and “genre in which the service was used X times in the past” can be selected from the genre selection menu screen 72. The user can set the selected item by moving a cursor key to any one item via the inputting portion 58 and then pressing an OK key in this state. In FIG. 4, a “O” mark is put to the set item. These are true in the following explanation.

The “all genres” denotes the item that enables the user to utilize the backup viewing service in all genres. The “user's set genre” denotes the item that enables the user to utilize the backup viewing service in the genre that the user sets. The “genre viewed X times in the past” denotes the item that enables the user to utilize the backup viewing service in the program in the genre that the user viewed X times in the past. Here, “X” denotes any number of set times, and does not request whether or not the backup viewing service has been utilized actually. The “genre in which the service was used X times in the past” denotes the item that enables the user to utilize the backup viewing service in the program in the genre that the user utilized X times in the past. Here, “X” denotes any number of set times. In this manner, the genre in which the user can utilize the backup viewing service is selected from any one of above three items.

For example, as shown in FIG. 4, when the item of “user's set genre” is selected from the genre selection menu screen 72, a “genre in which the backup viewing service is used” screen 73 is displayed on the displaying portion 60. In the screen 73, “sports”, “overseas”, and “gambling” are set.

Also, when the item of the “genre viewed X times in the past” is selected, a “number-of-times setting” screen 74 is displayed on the displaying portion 60. In the screen 74, the “genre viewed 3 times or more in the past” is set as the genre in which the backup viewing service is used.

Also, when the item of the “genre in which the service was used X times in the past” is selected, a “number-of-times setting” screen 75 is displayed on the displaying portion 60. In the screen 75, the “genre in which the backup viewing service was used 4 times or more in the past” is set as the genre in which the backup viewing service is used.

FIG. 5 is a flowchart showing setting process procedures done when the “genre selection” is selected on the main menu screen 71. This process program is stored in a memory in the controlling portion 61, and is executed by a processor of the controlling portion 61 when the “genre selection” is selected.

First, the controlling portion 61 displays the genre selection menu screen 72 on the displaying portion 60 (step S1). Then, the controlling portion 61 discriminates which choice item is appointed by the user via the inputting portion 58 (step S2). When the choice item is “all genres”, the controlling portion 61 sets that the backup viewing service is available in all genres (step S3). Also, the choice item is “user's set genre”, the controlling portion 61 displays the genre choosing screen 73 on the displaying portion 60 (step S4). The controlling portion 61 sets that the backup viewing service is available in the genre selected by the user via the inputting portion 58 (step S5).

Also, the choice item is the “genre viewed X times in the past”, the controlling portion 61 displays the “number-of-times setting” screen 74 on the displaying portion 60 (step S6). Then, the controlling portion 61 sets the number of set viewing times input by the user via the inputting portion 58 (the number of set times every genre) (step S7). Also, the choice item is the “genre in which the service was utilized X times in the past”, the controlling portion 61 displays the “number-of-times setting” screen 75 on the displaying portion 60 (step S8). Then, the controlling portion 61 sets the number of set times that are input by the user via the inputting portion 58 (the number of set times of the backup viewing service) (step S9). The present process is completed after the process in step S3, S5, S7, or S9.

FIG. 6 is a view showing a distributed data selection menu screen 81 transferred when a “distributed data selection” is selected on the main menu screen 71. In the distributed data selection menu screen 81 displayed on the displaying portion 60, the items of “fast playback file” and “digest contents” can be selected. In FIG. 6, the “digest contents” is selected.

FIG. 7 is a flowchart showing setting process procedures done when the “distributed data selection” is selected on the main menu screen 71. This process program is stored in the memory of the controlling portion 61, and is executed by the processor in the controlling portion 61 when the “distributed data selection” is selected.

First, the controlling portion 61 displays the distributed data selection menu screen 81 on the displaying portion 60 (step S11). The controlling portion 61 discriminates the type of distributed data that is selected by the user via the inputting portion 58 (step S12). If the type of the distributed data selected is the “fast playback file”, the controlling portion 61 sets the distributed data provided in the backup viewing service to the fast playback file (step S13). Then, the present is ended. In contrast, if the type of the distributed data selected in step S12 is the “digest contents”, the controlling portion 61 sets the distributed data provided in the backup viewing service to the digest contents (step S14). Then, the present process is ended.

FIG. 8 is a view showing a “picture-quality-utilized-in-service choosing” menu screen 84 shifted when a “picture-quality-utilized-in-service selection” is selected on the main menu screen 71. In the “picture-quality-utilized-in-service choosing” menu screen 84 displayed on the displaying portion 60, any one item out of “degradation in picture quality high”, “degradation in picture quality middle” and “degradation in picture quality low” can be selected. In FIG. 8, the item of “degradation in picture quality middle” is selected.

FIG. 9 is a flowchart showing setting process procedures done when the “picture-quality-utilized-in-service selection” is selected on the main menu screen 71. This process program is stored in the memory of the controlling portion 61, and is executed by the processor in the controlling portion 61 when the “picture-quality-utilized-in-service selection” is selected.

First, the controlling portion 61 displays the “picture-quality-utilized-in-service choosing” menu screen 84 on the displaying portion 60 (step S21). The controlling portion 61 discriminates a degree of degradation in picture quality selected by the user via the inputting portion 58 (step S22). If a selected degree of degradation in picture quality is the “degradation in picture quality high”, the controlling portion 61 sets a degree of degradation in picture quality to the “degradation in picture quality high” (see FIG. 2(D)) (step S23). Similarly, if a selected degree of degradation in picture quality is the “degradation in picture quality middle”, the controlling portion 61 sets a degree of degradation in picture quality to the “degradation in picture quality middle” (step S24). If a selected degree of degradation in picture quality is the “degradation in picture quality low”, the controlling portion 61 sets a degree of degradation in picture quality to the “degradation in picture quality low” (step S25). The present process is completed after the process in step S23, S24, or S25.

Respective items that are set in this manner are saved in the setting saving portion 56 (see FIG. 2), and are referred to by the controlling portion 61 as the case may be.

Next, an operation for utilizing the backup viewing service by using the set number of viewing times will be explained hereunder. The number of viewing times of the digital broadcasting program that the user watched is counted in respective genres of “sports”, “comedy”, “gambling”, and the like, and is saved in a number-of-viewing-times database in the genre saving portion 57.

FIG. 10 is a view showing the number-of-viewing-times database in the genre saving portion 57. As described above, the number-of-viewing-times database for storing the number of viewing times every genre is provided in the genre saving portion 57. Concretely, 3 times is stored as the number of viewing times of “sports”, 5 times is stored as the number of viewing times of “politics”, 4 times is stored as the number of viewing times of “economy”, 8 times is stored as the number of viewing times of “overseas”, and 30 times is stored as the number of viewing times of “gambling”. Then, when the program in the genre “overseas” is viewed on the mobile terminal device 50, the number of viewing times of “overseas” is updated to 9 times.

FIG. 11 is a flowchart showing process procedures in utilizing the backup viewing service by using the number of viewing times. This process program is stored in the memory of the controlling portion 61, and is executed by the processor in the controlling portion 61 when the viewing of the program is started.

First, the controlling portion 61 acquires the genre of the broadcasting program being viewed now from the digital broadcasting signal (step S31). The controlling portion 61 discriminates whether or not the number of viewing times exceeds the set number of viewing times, by comparing the number of viewing times stored in the number-of-viewing-times database (see FIG. 10) with the set number of viewing times saved in the setting saving portion 56 (see FIG. 2(B)) (step S32). In step S32, if the number of viewing times exceeds the set number of viewing times, the controlling portion 61 sets the utilization state (see FIG. 2(A)) of the backup viewing service in this genre, which is saved in the setting saving portion 56, to “OK” (step S33). That is, the utilization OK/NG situation table shown in FIG. 2(A) is updated. Accordingly, the backup viewing service is this genre can be set available.

Then, the controlling portion 61 increases a count value of the number of viewing times in this genre in the number-of-viewing-times database (see FIG. 10) by 1 (step S34). Then, the present process is ended. In contrast, in step S32, if the number of viewing times is below the set number of viewing times, the controlling portion 61 increases a count value of the number of viewing times in this genre in the number-of-viewing-times database (see FIG. 10) by 1 (step S35), while not changing the setting of the utilization state of the backup viewing service in this genre from “NG”. Then, the present process is ended.

In this manner, if the “genre viewed X times in the past” is selected from the genre selection menu screen 72, the controlling portion 61 refers to the set number of viewing times saved in the setting saving portion 56 and the number of viewing times saved in the genre saving portion 57 and compares them mutually. If the number of viewing times exceeds the set number of viewing times, it is set automatically that the backup viewing service is available in that genre. As a result, a time and labor required to check whether or not the backup viewing service can be utilized every program of the digital broadcasting can be omitted.

Next, an operation for utilizing the backup viewing service by using the set number of service utilizing times will be explained hereunder. The number of utilized times of the broadcasting program in which the user utilized the backup viewing service is counted in respective genres of “sports”, “comedy”, “gambling”, and the like, and is saved in the genre saving portion 57.

FIG. 12 is a view showing the number-of-used-times-of-backup-service database in the genre saving portion 57. The number-of-used-times-of-backup-service database for storing the number of utilized times of the backup viewing service every genre is provided in the genre saving portion 57. Concretely, 2 times is stored as the number of used times of “sports”, 6 times is stored as the number of used times of “politics”, 4 times is stored as the number of used times of “economy”, 10 times is stored as the number of used times of “overseas”, and 32 times is stored as the number of used times of “gambling”. Then, when the backup viewing service is used in the program in the genre “politics” on the mobile terminal device 50, the number of used times of “politics” is updated to 7 times.

FIG. 13 is a flowchart showing process procedures in utilizing the backup viewing service by using the number of used times. This process program is stored in the memory of the controlling portion 61, and is executed by the processor in the controlling portion 61 when the viewing of the program is started.

First, the controlling portion 61 acquires the genre of the broadcasting program being now viewed from the digital broadcasting signal (step S41). The controlling portion 61 discriminates whether or not the number of used times exceeds the set number of service used times, by comparing the number of utilized times stored in the number-of-used-times-of-backup-service database (see FIG. 12) with the set number of service used times saved in the setting saving portion 56 (step S42). In step S42, if the number of used times exceeds the set number of service used times, the controlling portion 61 sets the utilization state of the backup viewing service in this genre, which is saved in the setting saving portion 56, to “OK” (step S43). That is, the utilization OK/NG situation table shown in FIG. 2(A) is updated. Accordingly, the backup viewing service is this genre can be set available. Then, the controlling portion 61 increases a count value of the number of used times in this genre in the number-of-used-times-of-backup-service database (see FIG. 12) by 1 (step S44). Then, the present process is ended. In contrast, in step S42, if the number of used times is below the set number of service used times, the controlling portion 61 increases a count value of the number of viewing times in this genre in the number-of-used-times-of-backup-service database (see FIG. 12) by 1 (step S45), while not changing the setting of the utilization state of the backup viewing service in this genre from “NG”. Then, the present process is ended.

In this manner, if the “genre in which the service was utilized X times in the past” is selected from the genre selection menu screen 72, the controlling portion 61 refers to the set number of service used times saved in the setting saving portion 56 and the number of used times saved in the genre saving portion 57 and compares them mutually. If the number of used times exceeds the set number of service used times, it is set automatically that the backup viewing service is available in that genre. As a result, a time and labor required to check whether or not the backup viewing service can be utilized every program of the digital broadcasting can be omitted.

Next, an operation for utilizing the backup viewing service by using a set degree of degradation in picture quality will be explained hereunder. As described above, the user selects any one of “high”, “middle”, and “low” as the degree of degradation in picture quality. The degree of degradation in picture quality in utilizing the backup viewing service, which is selected by the user, is set in the setting saving portion 56.

FIG. 14 is a table showing a bit error rate (BER) corresponding to a degree of degradation in picture quality. This table is provided in the BER evaluating portion 59. The BER set values corresponding to “high”, “middle”, and “low” of the degree of degradation in picture quality are shown in this table. More particularly, the BER set value is 10-4 when “the degradation in picture quality is high”, the BER set value is 10-5 when “the degradation in picture quality is middle”, and the BER set value is 10-6 when “the degradation in picture quality is low”.

FIG. 15 is a flowchart showing starting process procedures of the backup viewing service due to the degradation in picture quality. This process program is stored in the memory of the controlling portion 61, and is executed by the processor in the controlling portion 61 when the viewing of the program is started.

First, the controlling portion 61 causes the BER evaluating portion 59 to measure the bit error arte (BER) of the program, which the user is viewing, of the digital broadcasting (step S51). Then, the controlling portion 61 discriminates whether or not the measured BER value of the digital broadcasting exceeds the set value (see FIG. 14) (step S52). In step S52, if the measured BER value exceeds the set value, the controlling portion 61 starts the use of the backup viewing service (step S53). In starting the utilization of the backup viewing service, the mobile terminal device 50 transmits the utilization set information and the viewing NG information to the backup viewing service server 20. Then, the present process is ended. Here, the information about the utilization OK/NG situation of the backup viewing service every genre shown in FIG. 2, the type of distributed data, etc. are contained in the utilization set information. Also, the information about a time at which the viewing is disabled, a time at which the viewing is enabled again, etc. are contained in the viewing NG information. In contrast, in step S52, if the measured BER value is below the set value, the present process is ended as it is.

In this manner, the utilization OK/NG situation of the backup viewing service can be decided by using the degree of degradation in picture quality that the user sets. Therefore, the backup viewing service is rendered unavailable when the degradation in picture quality is slight. As a result, the lack of the resources in the backup viewing service server 20 caused when the backup viewing service is provided repeatedly can be solved.

Also, in FIG. 15, when the measured BER value is in excess of the set value (see FIG. 14), the utilization of the backup viewing service is started only in the genre (see FIG. 2(A)) in which the utilization of the backup viewing service is set to “OK” in the utilization OK/NG situation table. Therefore, the utilization of the backup viewing service is not started in the genre in which the utilization of the backup viewing service is set to “NG”. In this case, it is of course that, when the utilization should be started in all genres, “OK” may be set in all genres in the utilization OK/NG situation table.

Next, an operation taken when the user deletes manually the distributed data that is recorded in the backup viewing service will be explained hereunder. Such a situation may be considered that, when the viewing is disabled in course of watching of the program in which the user possesses an interest and then such broadcasting program is recorded by the backup viewing service server, the distribution of the digest contents and fast playback file is not needed for user's convenience. However, if such situation is left as it is, the unnecessary contents data for the backup viewing service are distributed automatically even in the situation the user can watch the digital broadcasting again.

In order to prevent such situation, while the watching of the broadcasting program is disabled, the user can command the backup viewing service server 20 to suspend the recording and delete the contents data via the mobile terminal device 50 by using a packet communication. FIG. 16 is a view showing a suspending operation of the backup viewing service by the manual operation. When the viewing of the digital broadcasting program is disabled and thus the backup viewing service should be utilized, a service suspension accepting screen 91 for calling upon the user to decide whether or not the utilization of the backup viewing service should be suspended is displayed on the displaying portion 60. Then, the process is carried out in response to the user's instruction.

FIG. 17 is a flowchart showing suspending operation process procedures of the backup viewing service. This process program is stored in the memory of the controlling portion 61, and is executed by the processor in the controlling portion 61 when the viewing of the program is disabled and the backup viewing service is utilized.

First, the controlling portion 61 checks whether or not the user is now utilizing the backup viewing service (step S61). In step S61, if the backup viewing service is now in use, the controlling portion 61 causes the displaying portion 60 to display the service suspend accepting screen (see FIG. 16) (step S62). Then, the controlling portion 61 discriminates whether or not the user's command for the service suspension is accepted via the inputting portion 58 (step S63). In step S63, if the service suspend command is accepted, the controlling portion 61 instructs the backup viewing service server 20 via the radio base station 40 and the public telephone network 30 to suspend the backup viewing service (step S64). Then, the present process is ended.

In contrast, in step S63, if the service continue command is accepted, the controlling portion 61 continues the backup viewing service (step S65). Then, the present process is ended. In contrast, in step S61, if the backup viewing service is not in use, the present process is ended as it is.

In this manner, when the backup viewing service is not needed even though the programs belongs to the genre in which the user possesses an interest, the user can suspend the backup viewing service at will.

FIG. 18 is a flowchart showing distributing process procedures of the contents data for the backup viewing service in the backup viewing service server 20. This process program is stored in the memory medium (not shown) in the backup viewing service server 20, and is executed by the processor (not shown) in the backup viewing service server 20.

First, the backup viewing service server 20 discriminates whether or not the utilization set information and the viewing NG information have been received from the mobile terminal device 50 via the public telephone network 30 (step S71). In step S71, if such information have not been received, the present process is ended. In contrast, in step S71, if the utilization set information and the viewing NG information have been received, the backup viewing service server 20 edits the contents data for the backup viewing service by using the recorded broadcasting program in accordance with these information (step S72). Then, the backup viewing service server 20 distributes the edited contents data for the backup viewing service (step S73). Then, the present process is ended.

Here, the backup viewing service server 20 may receive in advance the utilization set information from the mobile terminal device 50. In this case, as the information received when the viewing of the program is disabled, only the viewing NG information containing a time at which the viewing is disabled, etc. is required.

As described above, according to the backup viewing service system of the present embodiment, the user's interest and wishes can be reflected upon utilizing the backup viewing service. Also, the setting indicating whether or not the user should utilize the backup viewing service every broadcasting program can be omitted.

Also, the user can set freely a degree of degradation in picture quality in utilizing the backup viewing service. Since the backup viewing service is rendered unavailable when the degradation in picture quality is slight, the lack of the resources in the backup viewing service server caused when the backup viewing service is provided repeatedly can be solved.

Also, when the backup viewing service is not needed even though the programs belongs to the genre in which the user possesses an interest, the user can suspend the backup viewing service at will.

Also, when the items of “genre selection”, “distributed data selection”, and “picture-quality-utilized-in-service selection” are displayed on the main menu screen and the user may select any one item of them, the operability in setting the utilization conditions for the backup viewing service can be enhanced.

Also, when the user may select the digest contents or the fast playback file from the distributed data selection menu screen, the type of the backup viewing contents distributed by the backup viewing service can be made clear.

Also, the backup viewing service server can edit the backup viewing contents to be provided, in response to the user's set contents. Also, since the utilization conditions can be set in course of reception of the broadcasting program or prior to the start of reception, user's convenience of the backup viewing service can be improved.

Here, the present invention is not limited to the matters shown in the above embodiments. The present invention is susceptible to variations and adaptations, which are made based on the description of the specification and well known technologies by those skilled in the art and are contained in a scope over which a protection is sought.

For example, in the above embodiment, the types of the distributed data (contents data for the backup viewing service) (see FIG. 2(C)) are set commonly in all genres. In this case, the distributed data may be set to the fast playback file or the digest contents every genre.

Also, in the above embodiment, the case where the mobile terminal device of the present invention is applied to the digital terrestrial broadcasting oriented to the cellular phone (one-segment broadcasting) is illustrated. In this case, the present invention is also applicable to the Internet broadcasting, the digital satellite broadcasting, the common digital terrestrial broadcasting, and the like.

### INDUSTRIAL APPLICABILITY

The present invention possesses such an advantage that the user's interest and wishes can be reflected in utilizing the backup viewing service, and is useful to the mobile terminal device, the backup viewing service system, and the backup viewing service method, which utilize the backup viewing service when the broadcast program that is being received falls into the viewing impossible state in the digital terrestrial broadcasting, or the like.

1. A mobile terminal device that utilizes a backup viewing service when a broadcast program that is being received falls into a viewing impossible state, comprising:
an inputting portion which inputs a utilization condition for the backup viewing service;
a utilization condition setting portion which sets the input utilization condition for the backup viewing service;
a utilization condition discriminating portion which discriminates whether or not the set utilization condition is satisfied, when the broadcast program that is being received falls into the viewing impossible state; and
a service availability setting portion which sets the backup viewing service into available when the utilization condition is satisfied;
wherein the utilization condition setting portion sets a number of set times being input by the inputting portion every genre as the utilization condition of the backup viewing service; and
wherein the utilization condition discriminating portion discriminates that the utilization condition is satisfied, when a number of viewing times of the genre corresponding to the broadcast program that is being received exceeds the number of set times.

2. (canceled)

3. A mobile terminal device that utilizes a backup viewing service when a broadcast program that is being received falls into a viewing impossible state, comprising:
an inputting portion which inputs a utilization condition for the backup viewing service;
a utilization condition setting portion which sets the input utilization condition for the backup viewing service;
a utilization condition discriminating portion which discriminates whether or not the set utilization condition is satisfied, when the broadcast program that is being received falls into the viewing impossible state; and
a service availability setting portion which sets the backup viewing service into available when the utilization condition is satisfied;
wherein the utilization condition setting portion sets a number of set times of the backup viewing service being input by the inputting portion every genre as the utilization condition of the backup viewing service; and
wherein the utilization condition discriminating portion discriminates that the utilization condition is satisfied, when a number of utilizing times of the backup viewing service in the genre corresponding to the broadcast program that is being received exceeds the number of set times.

4-12. (canceled)

13. A program for causing a computer to function as respective portions of the mobile terminal device set forth in claim 1.

14. A program for causing a computer to function as respective portions of the mobile terminal device set forth in claim 2.
